(19) United States
(12) Patent Application Publication
(10) Pub. No.: US 2026/0077738 A1
(43) Pub. Date: Mar. 19, 2026

(54) TENSIONING DEVICE FOR A SAFETY BELT COMPONENT

(71) Applicant: Autoliv Development AB, Vargarda (SE)

(72) Inventors: Ole SCHARNBERG, Hamburg (DE); Andre LITTMANN, Alveslohe (DE); Dominik JUNGE, Elmshorn (DE)

(21) Appl. No.: 19/109,371

(22) PCT Filed: Sep. 6, 2023
(86) PCT No.: PCT/EP2023/074414

§ 371 Date: Mar. 6, 2025

(30) Foreign Application Priority Data
Sep. 8, 2022 (DE) 10 2022 122 769.3

(51) Int. Cl. B60R 22/185

(52) U.S. Cl. CPC B60R 22/185

(57) ABSTRACT

A tensioning device for a safety belt component, comprising a gas generator for generating a pressurized gas, a piston which can be driven by the pressurized gas, a tension cable which is connected to the piston and can be connected to the safety belt component to be set into a tightening motion, and a tightening tube for receiving and guiding the piston and a receptacle that accommodates the gas generator.

The present invention relates to a tensioning device for a safety belt component, comprising a gas generator for generating a pressurized gas, a piston which can be driven by the pressurized gas, a tension cable which is connectable to the piston and can be connected to the safety belt component to be set into a tightening motion, a tightening tube for receiving and guiding the piston and a receptacle that accommodates the gas generator.

Such a tensioning device is known, for example, from DE 10 2020 103 157 A1 in which both the receptacle for the gas generator as well as a cable deflection outside the region exposed to the pressurized gas are formed as a single piece in a guide block. A tightening tube is arranged on the guide block, into which the pressurized gas generated by the gas generator enters upon triggering the tensioning device so that the piston arranged in the tightening tube is driven by the pressurized gas. On the side facing away from the tightening tube, the cable deflection formed in one piece in the guide block is shaped in such a way that the tension cable can be guided out of the guide block either in a straight line (if necessary offset parallel) in the direction of movement of the piston, or alternatively can be deflected by 90° or more. In order to change the offset of the tension cable to the direction of movement of the piston or to change the deflection angle with such a design of the guide block, the deflection block must be completely redesigned.

The object of the present invention is therefore that of at least partially eliminating the disadvantages described with respect to the prior art and in particular providing a tensioning device which can more easily be adapted to different requirements.

To achieve the object, it is proposed in particular that the tensioning device has a frame which is arranged on the side facing away from the tightening tube and through which the tension cable runs after it has emerged from a space of the safety belt component which can be acted upon by the pressurized gas. The frame can, for example, be made from a sheet metal which has been formed in particular into a shape with a U-shaped cross-section. The frame serves in particular to accommodate additional components of the tensioning device. In particular, components which serve for cable deflection or cable guidance outside the space exposed to pressurized gas are attached to the frame. The frame can therefore be designed in the same way for different applications of the tensioning device, while the components for deflecting the tension cable can be adapted to different applications (e.g., deflection by 90° or straight passage).

The receptacle for the gas generator is arranged in such a way that the pressurized gas generated by the gas generator enters the tightening tube and drives the piston there. Preferably, the receptacle is arranged in the tightening tube.

In addition, a cable guide can be provided through which the tension cable exits the tightening tube. The cable guide is arranged in a suitable sealing manner in the tightening tube and preferably also provides a seal along the tension cable.

Preferably, both the receptacle for the gas generator as well as the cable guide are arranged completely in the tightening tube.

In order to fix the frame to the tightening tube, it can be provided that the frame can have an engagement portion which, in the mounted state, is arranged within the tightening tube. In this case, it can in particular be provided that the engagement section interacts with the cable guide in the mounted state and additionally fixes it in the tightening tube. The cable guide and the engagement section of the frame can accordingly preferably be fixed simultaneously by pressing the tightening tube.

In a preferred embodiment, it is provided that the receptacle for the gas generator and the cable guide are formed as one piece, wherein the receptacle and the cable guide are arranged completely in the tightening tube.

Preferably, the tightening tube has a section with a circular cross-section in which the piston is arranged and along which the piston is driven by the pressure application. The tightening tube also has a region whose cross-section deviates from a circular cross-section. This region preferably has an oval cross-section. The receptacle and the cable guide are arranged in particular in the region of the tightening tube which deviates in its cross-section from the circular cross-section. The receptacle for the gas generator is arranged and designed in such a way that the pressurized gas generated by the gas generator is introduced directly into the tightening tube and can accordingly reach the piston directly. In particular, the pressurized gas is introduced into a region of the tightening tube in which its cross-sectional design changes. The pressurized gas is therefore not introduced into a space limited by the cable deflection and from there guided to the piston. This allows the pressurized gas to cool down slightly before it comes into direct contact with the tension cable arranged in the tightening tube.

A solution to the object mentioned at the outset is provided in particular with a tensioning device having the features of independent claim 1. Other solutions and advantageous developments of the tensioning device are specified in the description above and in the following as well as in the dependent claims, wherein individual features of the advantageous developments can be combined with one another in a technically sensible manner.

The object is achieved in particular by a tensioning device with the features mentioned at the outset, in which the tension cable extends through a frame at the end facing away from the tensioner tube, and a deflection element is mounted in the frame, wherein the tension cable bears directly against the deflection element. The deflection element is an independent component which is accordingly independent of a cable guide through which the tension cable is guided out of the tightening tube. The deflection element can accordingly be adapted to the particular application of a tensioning device without other components of the tensioning device having to be changed.

In order to deflect the tension cable, the deflection element has a deflection surface which is circular in cross-section at least in sections and against which the tension cable bears. The deflection element is in particular formed with a deflection surface that is circular in cross section by at least 90°, preferably by at least 120° and particularly preferably by at least 180° on its peripheral surface. The deflection element is arranged in particular in such a way that the tension cable bears against the deflection surface with the inner section of its region deformed by the deflection surface.

The deflection element is mounted in the frame in particular by means of a bushing. The bushing preferably extends completely through the deflection element and is arranged in particular on both sides of the deflection element in corresponding openings in the frame, which is in particular designed U-shaped. The bushing can be firmly connected to the frame on at least one side by plastic deformation. In its vehicle-mounted position, the tensioning device can be attached to the vehicle through the bushing by means of a suitable fastening element.

For storage in the frame, the deflection element has an in particular circular receptacle through which the bushing is guided. In a particularly preferred embodiment, the circular receptacle is arranged eccentrically to the circular deflection surface of the deflection element, whereby the deflection element can be more easily adapted to different applications (linear passage of the tension cable or deflection of the tension cable). Depending on whether the tension cable is to be deflected by 90°or whether the tension cable is to be guided past the deflection element in a straight line or with an offset to the direction of movement of the piston, different deflection elements can be used. In particular, the receptacle is arranged eccentrically offset towards the circular deflection surface.

In one embodiment, the deflection element can be flat at a portion where the traction cable does not rest.

For an overall space-saving arrangement and/or to avoid a rotational movement of the deflection element about its bearing, it can be provided that an outer contour of another component of the tensioning device is adapted to the outer contour of the deflection element. In particular, the additional component rests against the outer contour of the deflection element at least during a tightening process, whereby a rotational movement of the deflection element can also be prevented.

In this context, it is particularly provided that a plug element, which is designed in particular as a separate component of the tensioning device, is adapted in its outer contour to the outer contour of the deflection element. On the one hand, the plug element has a socket or a plug to which a signal cable can be connected to trigger the gas generator. On the other hand, the plug element is electrically connected to the connections of the gas generator.

The invention and the technical environment are explained below by way of example with reference to the figures. Schematically, in the figures:

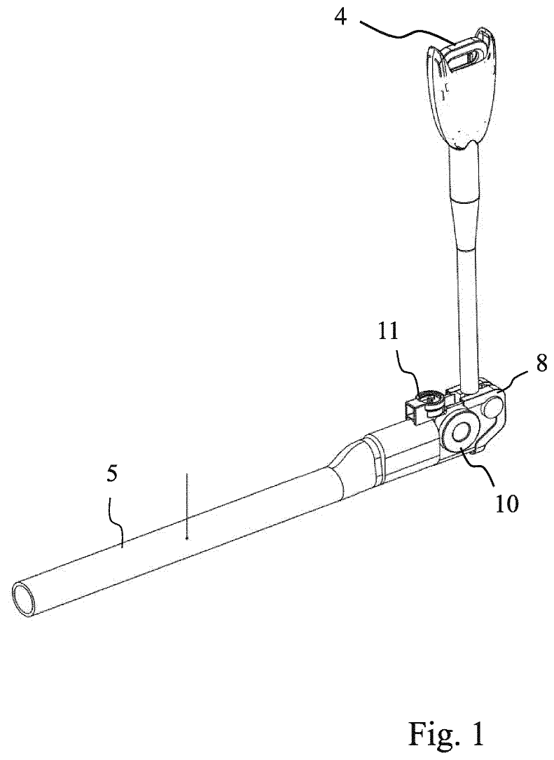

FIG. 1: shows a perspective view of a tensioning device,

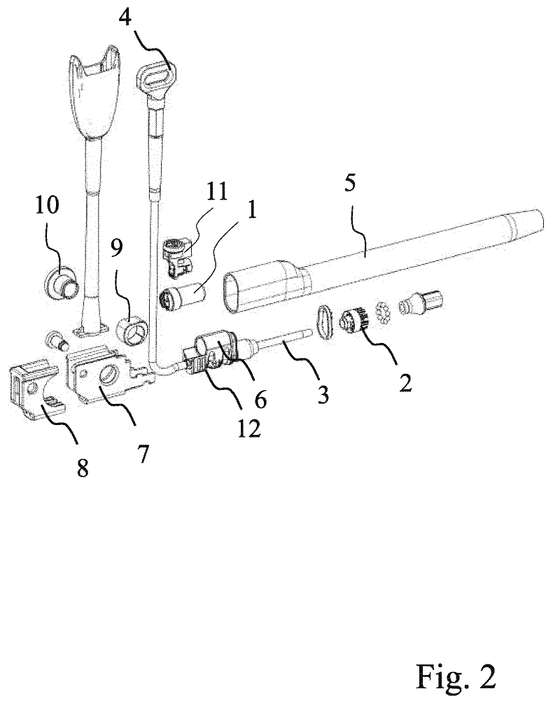

FIG. 2: shows an exploded view of the tensioning device,

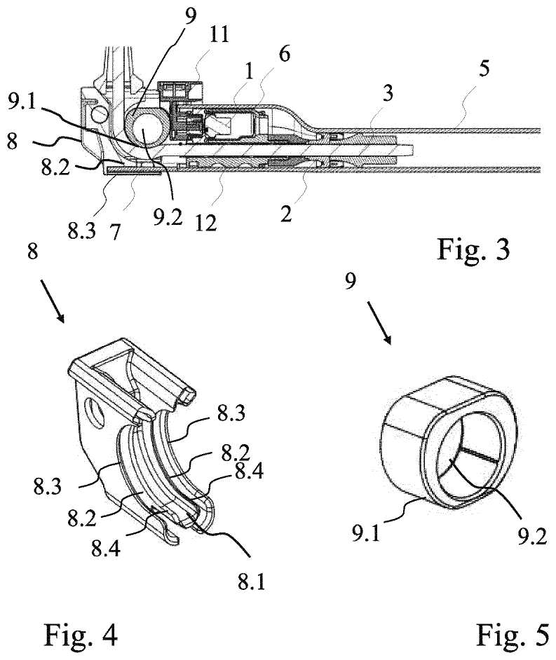

FIG. 3: shows a sectional view through the tensioning device,

FIG. 4: shows a perspective view of an end cap,

FIG. 5: shows a perspective view of a deflection element, and

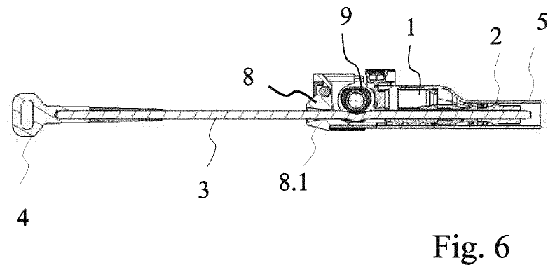

FIG. 6: shows a sectional view through another embodiment of a tensioning device with a straight cable passage.

The tensioning device shown in FIG. 1 to 3 comprises a tightening tube 5 in which a piston rod 2 is arranged in a mounted state. The piston 2 is firmly connected to a tension cable 3 which is inserted into the tightening tube 5 and which is connected on its other side to a safety component 4 to be set into a tightening motion.

The tensioning device also comprises a component in which a cable guide 12 and a receptacle 6 for a gas generator 1 are formed. In the mounted state, this component is arranged in a section of the tightening tube 5 which has an oval-shaped cross-section.

The tensioning device also comprises a frame 7 which, in the mounted state, is arranged with an engagement section within the tightening tube 5.

A deflection element 9 is mounted in the frame 7 by means of a bushing 10, which passes through a receptacle 9.2 of the deflection element 9 in the mounted state and is arranged on both sides of the deflection element 9 in corresponding openings of the frame 7, which is U-shaped in cross section.

The tensioning device also comprises an end cap 8 which is attached to the frame 7 from a side facing away from the tightening tube 5.

As can be seen in particular from FIG. 4, the end cap 8 has several sections which, in the mounted state, are arranged within the frame 7.

Accordingly, the end cap 8 has a guide section 8.1 which is arranged within the frame in the mounted state and which is trough-shaped and has a curvature along the direction of the tension cable.

The end cap 8 also has inner sealing sections 8.2 which, in the mounted state, are arranged on the inside of the frame 7 and bear against the frame 7. At the same time, outer sealing sections 8.3 bear against an outer side of the frame 7. By combining inner sealing sections 8.2 and outer sealing sections 8.3, the frame 7 is sealed on the side facing away from the tightening tube 5 so that pressurized gas escaping from the cable guide 12 cannot escape from the front side of the frame 7, but is deflected.

In addition, the side surfaces of the trough-like guide section 8.1 are designed such that when the end cap 8 is inserted, they are pressed onto the tension cable 3 on both sides by the frame 7, whereby the tension cable 3 is secured against unintentional movement. Accordingly, the end cap 8 forms securing sections 8.4. However, the force exerted by the securing sections 8.4 on the tension cable 3 is not so great that the tightening process is hindered.

As can be seen from FIG. 5, the deflection element 9 has an outer surface referred to as deflection surface 9.1 which has a circular shape in the sectional view shown in FIG. 3. The receptacle 9.2 for the bushing 10 is arranged eccentrically to the deflection surface 9.1 and in particular offset towards the deflection surface 9.1.

The tensioning device also comprises a plug element 11 via which a cable can be connected to the gas generator 1. The outer contour of the plug element 11 is adapted to the outer contour of the deflection element 9.

To initiate a tightening process, the gas generator 1 is ignited, whereby pressurized gas enters the section of the tightening tube 5 with a circular cross-section and drives the piston 2 there along the tightening tube 5. The driven piston 2 sets the safety belt component 4 into a tightening motion, wherein the tension cable 3 is deflected by the deflection element 9 and the guide section 8.1 of the end cap 8.

While in the shown exemplary embodiment the tension cable 3 is deflected by approximately 90°, the tensioning device can also be adapted by exchanging a few parts so that the tension cable 3 exits the frame 7 in a linear extension of the direction of movement of the piston 2 as shown in FIG. 6.

In the embodiment in FIG. 6, only the end cap 8 has been exchanged for this, wherein the guide section 8.1 would be designed as an opening through which the tension cable 3 emerges. In order to achieve an optionally different deflection and/or alignment of the tension cable 3, the deflection element 9 can also be designed differently.

With the proposed tensioning device, it can therefore only be adapted to other applications by replacing individual components.

### LIST OF REFERENCE SIGNS

1 Gas generator
2 Piston
3 Tension cable
4 Safety belt component
5 Tensioner tube
6 Receptacle
7 Frame
8 End cap
8.1 Guide section
8.2 Inner sealing section
8.3 Outer sealing section
8.4 Securing section
9 Deflection element
9.1 Deflection surface
9.2 Bushing receptacle
10 Bushing
11 Plug element
12 Cable guide

1. A tensioning device for a safety belt component, having
an inflator for generating a pressurized gas,
a piston that can be driven by the pressurized gas,
a tension cable that is connected to the piston and is connectable to a safety belt component to be put into a tensioning movement,
a tensioner tube for receiving and guiding the piston, and
a receptacle that accommodates the gas generator,
wherein
the tension cable extends through a frame at the end facing away from the tensioner tube and a deflection element is mounted in the frame, wherein the tension cable bears directly against the deflection element.

2. The tensioning device according to claim 1, wherein the deflection element has a deflection surface which is circular in cross-section at least in sections and against which the tension cable bears.

3. The tensioning device according to claim 1, wherein the deflection element is mounted in the frame by means of a bushing and preferably has a circular receptacle for the bushing.

4. The tensioning device according to claim 2 , wherein the circular receptacle is arranged eccentrically in relation to the circular deflection surface.

5. The tensioning device according to claim 1, wherein the deflection element is flat in a section against which the tension cable does not bear.

6. The tensioning device according to claim 1, wherein an outer contour of a further component of the tensioning device is adapted to the outer contour of the deflection element.

7. The tensioning device according to claim 6, wherein a plug element for electrically contacting the gas generator is adapted in its outer contour to the outer contour of the deflection element.

8. The tensioning device according to claim 1, wherein the receptacle for the gas generator is formed integrally with a cable guide, through which the tension cable is guided out of the tensioner tube, wherein the receptacle and the cable guide are arranged entirely within the tensioner tube.

9. The tensioning device according to claim 8, wherein the receptacle and the cable guide are arranged in a region of the tensioner tube in which the tensioner tube deviates from a circular cross-section.

10. The tensioning device according to claim 9, wherein in the triggered case the pressurized gas is applied to the piston through the change in cross-section of the tensioner tube.
